(19) United States
(12) Patent Application Publication
(10) Pub. No.: US 2003/0164427 A1
(43) Pub. Date: Sep. 4, 2003

(54) ESD coatings for use with spacecraft

(76) Inventors: Paul J. Glatkowski, Littleton, MA (US); John W. Connell, Yorktown, VA (US); David H. Landis JR., Barrington, RI (US); Joseph G. Smith JR., Smithfield, VA (US); Joseph W. Piche, Raynham, MA (US)

Correspondence Address: MORRISON & FOERSTER LLP, 1650 TYSONS BOULEVARD, SUITE 300, MCLEAN, VA, 22102, US

(21) Appl. No.: 10/244,589

(22) Filed: Sep. 17, 2002

Related U.S. Application Data
(60) Provisional application No. 60/322,728, filed on Sep. 18, 2001.

(51) Int. Cl. B64G 1/22

(52) U.S. Cl. 244/158 R

(57) ABSTRACT

Spacecraft with electrostatic dissipative surfaces are disclosed herein. The surface has layer which includes a plurality of carbon nanotubes to incorporate electrical conductivity into space durable polymeric layers without degrading optical transparency, solar absorptivity or mechanical properties.

### REFERENCE TO RELATED APPLICATIONS

This application claims priority to U.S. Provisional Application No. 60/322,728 entitled “ESD Films” filed Sep. 18, 2001.

### BACKGROUND OF THE INVENTION

1. Field of the Invention

The present invention relates to the use of electrostactic dissipative (ESD) coatings. Particularly, the invention relates to ESD coatings comprising nanotubes for use on spacecraft.

2. Description of the Background

Future space mission concepts involving Gossamer spacecraft are actively being pursued by a variety of government agencies. Gossamer spacecraft are envisioned to be large, ultra-lightweight, deployable structures (Jenkins, C. H. M. Gossamer Spacecraft: Membrane and Inflatable Structures Technology for Space Applications, Volume 191, American Institute of Aeronautics and Astronautics 2001). By necessity, these structures are envisioned to be fabricated from flexible, compliant materials that must be folded or packaged into the small volumes that are available in conventional launch vehicles. Upon achieving orbit, the structure would deploy by mechanical, inflation, or other means into a large, ultra-lightweight functioning spacecraft. Gossamer spacecraft offer a significant cost advantage compared to on-orbit construction and the large size can enable some unique missions. Examples of gossamer spacecraft include solar sails, antennas, sunshields, rovers, radars, solar concentrators, and reflect arrays.

Materials represent one of several enabling technologies needed to make Gossamer spacecraft a reality. The materials used to fabricate Gossamer spacecraft must possess and maintain a specific and unique combination of properties over long time periods in a relatively harsh environment. The materials must be resistant to the radiation present in the desired spacecraft location and depending upon the function of the spacecraft must possess a combination of other properties as well. Desirable properties that are common among many of the mission concepts include sufficient electrical conductivity to prevent static charge build-up, low solar absorptivity (α), high thermal emissivity (ε), high optical transparency, toughness, tear and wrinkle resistance. The ability to be folded, seamed, bonded to, melt or solution processed into precise shapes is also important.

In orbit, spacecraft are exposed to charged species such as electrons and protons. Polymers are typically insulators and will accumulate charge until they reach the saturation point. This stored charge can be dissipated in a single, catastrophic event (arc-discharge) causing damage to the spacecraft structure and/or electronics, adjacent spacecraft, or to astronauts in the vicinity. Thus, there is a need to incorporate sufficient electrical conductivity into space durable polymers to fulfill performance requirements for future NASA mission needs.

Polymeric materials represent enabling technology for future concepts for large, ultra-lightweight, deployable spacecraft, such as Gossamer space structures. However, no materials exist which possess the desired combination of properties necessary. Most of the missions have projected lifetimes of 5-10 years in space and due to weight requirements, require lightweight, flexible, radiation resistant materials.

Recently several new materials have emerged which offer improvements in resistance to space-based radiation. The behavior of these materials, such as CP-1, TOR-LM, CP-2, and TOR-NC, to radiation and atomic oxygen has been characterized in ground-based and space-flight exposure experiments and they are beginning to be used on spacecraft. The chemical structures of some of these polymers are provided herein.

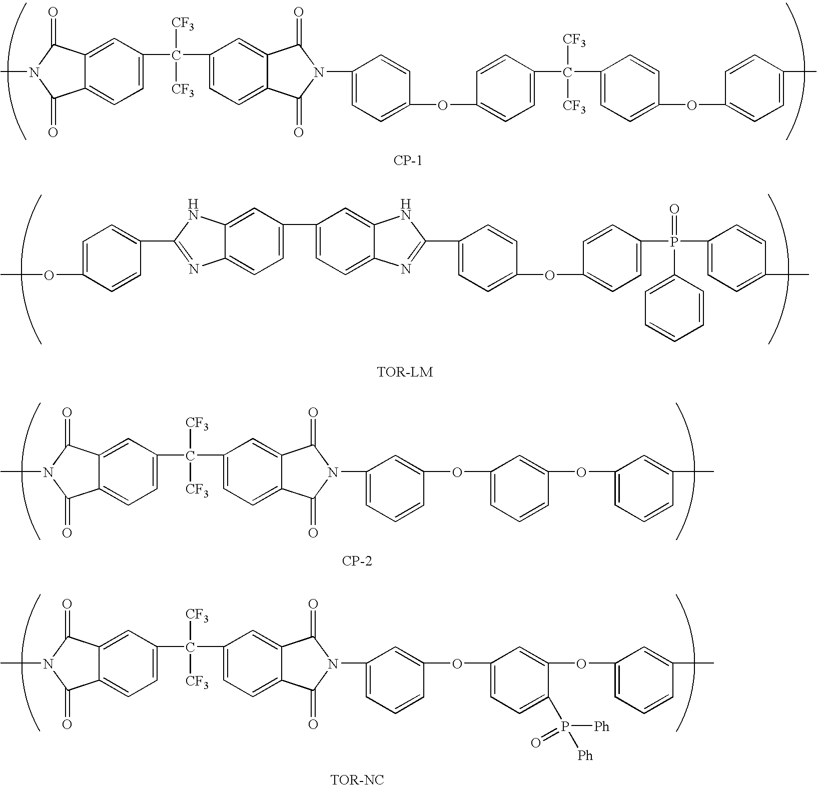

These materials are described, for example, in the following U.S. patents. CP-1 and CP-2: U.S. Pat. Nos. 4,595,548 and 4,603,061 issued Jun. 17, 1986 and Jul. 29, 1986, respectively. TOR-LM: U.S. Pat. No. 5,270,432, issued Dec. 22, 1993 and U.S. Pat. No. 5,317,078, issued May 31, 1994 and U.S. Pat. No. 5,412,059, issued May 2, 1995.

Carbon nanotubes are the most recent addition to the growing members of the carbon family. Carbon nanotubes can be viewed as a graphite sheet rolled up into a nanoscale tube form to produce the so-called single-wall carbon nanotubes (SWCNTs) Harris, P. F. “Carbon Nanotubes and Related Structures: New Materials for the Twenty-first Century”, Cambridge University Press: Cambridge, 1999. There may be additional graphene tubes around the core of a SWNT to form multi-wall carbon nanotubes (MWNTs). These elongated nanotubes may have a diameter in the range from few angstroms to tens of nanometers and a length of several micrometers up to millimeters. Both ends of the tubes may be capped by fullerene-like structures containing pentagons.

Carbon nanotubes can exhibit semiconducting or metallic behavior (Dai, L.; Mau, A. W. M. Adv. Mater. 2001, 13, 899). They also possess a high surface area (400 m²/g for nanotube “paper”) (Niu, C.; Sichel, E. K.; Hoch, R.; Moy, D.; Tennent, H. “High power electrochemical capacitors based on carbon nanotube electrodes”, Appl. Phys. Lett. 1997, 70, 1480-1482), high electrical conductivity (5000 S/cm) (Dresselhaus, M. Phys. World 1996, 9, 18), high thermal conductivity (6000 W/mK) and stability (stable up to 2800° C. in vacuum) (Collins, P. G.; Avouris, P. “Nanotubes for electronics”, Sci. Am. 2000, Dec. 62-69) and good mechanical properties (tensile strength 45 billion pascals). These interesting properties make carbon nanotubes very attractive for a variety of potential applications.

However, the use of carbon nanotubes in spacecraft for ESD protection and resistance to space-based radiation has not been described heretofore.

### SUMMARY OF THE INVENTION

The instant invention utilizes advantageous properties of carbon nanotubes to incorporate electrical conductivity into space durable polymeric layers without degrading optical transparency, solar absorptivity or mechanical properties. In this way, the instant inventors utilize carbon nanotubes within the context of space durable polymeric layers and films as a means of achieving sufficient electrical conductivity to mitigate static charge build-up.

The instant inventors have recognized several unexpected beneficial material property attributes. For example, the instant inventors have demonstrated, inter alia, those amounts carbon nanotubes needed to achieve acceptable electrical conductivity, while not dramatically effecting optical transmission, solar absorptivity and flexibility of thin films.

Accordingly, the instant invention provides, in a preferred embodiment, a spacecraft comprising a surface defining at least a portion of said spacecraft, wherein said surface comprises a layer of nanotubes effective for electrostatic discharge.

Preferably the spacecraft is a gossamer spacecraft, which may be solar sails, antennas, sunshields, rovers, radars, solar concentrators, or reflect arrays.

Preferably, the nanotubes may be single-walled nantubes (SWNTs), double-walled nantubes (DWNTs), multi-walled nanotubes (MWNTs), or mixtures thereof.

Preferably, the nanotubes are present in said layer at about 0.001 to about 1% based on weight. The nanotubes may also be oriented.

Preferably, the layers or films have a surface resistance in the range of about 10⁵ to about 10¹² ohms/square. Preferably the surface resistance is in the range about 10⁷ to about 10¹⁰ ohms/square.

In another preferred embodiment, the layers or films may further comprise a polymeric material, such as thermoplastics, thermosetting polymers, elastomers, conducting polymers and combinations thereof. Preferably, the polymeric material may comprise such materials such as polyethylene, polypropylene, polyvinyl chloride, styrenic, polyurethane, polyimide, polycarbonate, polyesters, fluoropolymers, polyethers, polyacrylates, polysulfides, polyamides, acrylonitriles, cellulose, gelatin, chitin, polypeptides, polysaccharides, polynucleotides or mixtures thereof. The layer may further comprise an additive selected from the group consisting of a dispersing agent, a binder, a cross-linking agent, a stabilizer agent, a coloring agent, a UV absorbent agent, and a charge adjusting agent. The additive may also be conductive polymers, particulate metals, particulate ceramics, salts, ionic additives or mixtures thereof in order to enhance electrical conduction

Preferably, the instant layer has a thickness between about 0.5 nm to about 1000 microns.

Preferably, the instant layer or film has a solar absorptivity of less than about 0.3. More preferably, the instant layer or film has a solar absorptivity of between about 0.01 to about 0.2.

Preferably, the layer or film has optical transparency retention of about 70% to about 99.9% that of a nanotube-free base material.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment provided herein, serve to explain the principles of the invention. Thus, for a more complete understanding of the present invention, the objects and advantages thereof, reference is now made to the following descriptions taken in connection with the accompanying drawings in which:

FIG. 1 is a plot of conductivity verses thickness for SWNT coatings according to one embodiment of the present invention;

FIG. 2 depicts a plot of the affect of high humidity on an ESD coating over an extended period of time according to one embodiment of the present invention;

FIG. 3 depicts a plot of surface resistivity versus temperature data for Si-DETA-50-Ti with 0.30% SWNT cast on to a glass slide according to one embodiment of the present invention;

FIG. 4 depicts a plot of surface resistivity versus temperature data for Si-DETA-50-Ti with 0.20% SWNT cast on to a glass slide according to one embodiment of the present invention;

FIG. 5 depicts a plot of surface resistivity versus test voltage data for Si-DETA-50-Ti with 0.3% SWNT cast on to a glass slide according to one embodiment of the present invention; and

FIG. 6 depicts the percent nanotubes cast on glass slides labeled with resistance measurements according to one embodiment of the present invention.

FIG. 7 depicts advantages of SWNTs used to impart electrical properties to films.

FIG. 8 depicts results showing how each of the three films resistivity (@500V) varied with temperature from −78 to +300° C.

FIG. 9 depicts resistivity in Ohms/Sq. for 1 mil polyimide films as voltage is reduced.

FIG. 10 depicts tensile properties for polyimides and TPO resins with and without nanotubes.

FIG. 11 depicts CTE Data on polyimide and TPO 1 mil films, with and without 0.1% SWnTs.

### DETAILED DESCRIPTION OF THE INVENTION

The preferred embodiments of the present invention and its advantages are understood by referring to the figures, wherein like numerals being used for like and corresponding parts of the various drawings.

The instant invention relates to, inter alia, the use of electrically conductive films comprising carbon nanotubes for ESD protection in spacecraft.

The spacecraft may be any vehicle for controlled traveling in space. Preferably, the spacecraft is a gossamer spacecraft. Gossamer spacecraft are known in the art and include solar sails, antennas, sunshields, rovers, radars, solar concentrators, or reflect arrays.

Carbon nanotubes are known and have a conventional meaning. (R. Saito, G. Dresselhaus, M. S. Dresselhaus, “Physical Properties of Carbon Nanotubes,” Imperial College Press, London U.K. 1998, or A. Zettl “Non-Carbon Nanotubes” Advanced Materials, 8, p. 443 (1996)). In a preferred embodiment, nanotubes of this invention comprises straight and bent multi-walled nanotubes (MWNTs), straight and bent double-walled nanotubes (DWNTs) and straight and bent single-walled nanotubes (SWNTs), and various compositions of these nanotube forms and common by-products contained in nanotube preparations such as described in U.S. Pat. No. 6,333,016 and WO 01/92381, which are incorporated herein by reference in their entirety.

In a preferred embodiment, the nanotubes comprise single walled carbon-based SWNT-containing material. SWNTs can be formed by a number of techniques, such as laser ablation of a carbon target, decomposing a hydrocarbon, and setting up an arc between two graphite electrodes. For example, U.S. Pat. No. 5,424,054 to Bethune et al. describes a process for producing single-walled carbon nanotubes by contacting carbon vapor with cobalt catalyst. The carbon vapor is produced by electric arc heating of solid carbon, which can be amorphous carbon, graphite, activated or decolorizing carbon or mixtures thereof. Other techniques of carbon heating are discussed, for instance laser heating, electron beam heating and RF induction heating. Smalley (Guo, T., Nikoleev, P., Thess, A., Colbert, D. T., and Smally, R. E., Chem. Phys. Lett. 243: 1-12 (1995)) describes a method of producing single-walled carbon nanotubes wherein graphite rods and a transition metal are simultaneously vaporized by a high-temperature laser. Smalley (Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)) also describes a process for production of single-walled carbon nanotubes in which a graphite rod containing a small amount of transition metal is laser vaporized in an oven at about 1200° C. Single-wall nanotubes were reported to be produced in yields of more than 70%. U.S. Pat. No. 6,221,330, which is incorporated herein by reference in its entirety, discloses methods of producing single-walled carbon nanotubes which employs gaseous carbon feedstocks and unsupported catalysts.

SWNTs are very flexible and naturally aggregate to form ropes of tubes. The formation of SWNT ropes in the coating or film allows the conductivity to be very high, while loading is very low, and results in a good transparency and low haze.

The instant films provide excellent conductivity and transparency at low loading of nanotubes. In a preferred embodiment, the nanotubes are present in the film at about 0.001 to about 1% based on weight. Preferably, the nanotubes are present in said film at about 0.01 to about 0.1%, which results in a good transparency and low haze.

The layer may have a surface resistance in the range of about 10⁵ to about 10¹² ohms/square. Preferably the surface resistance is in the range about 10⁷ to about 10¹⁰ ohms/square. Accordingly, the layer of nanotubes can provide adequate electrostatic discharge within this range.

The instant films also have volume resistivity in the range of about 10⁻² ohms-cm to about 10¹⁰ ohms-cm. The volume resistivities are determined as defined in ASTM D4496-87 and ASTM D257-99.

Total light transmittance refers to the percentage of energy in the electromagnetic spectrum with wavelengths of about 400 nm to about 700 nm that passes through the layers, thus necessarily including wavelengths of visible light. In a preferred embodiment, the film has a total light transmittance of about 70% or more. In another preferred embodiment, the film has a total light transmittance of about 85% or more. In another preferred embodiment, the film has a total light transmittance of about 90% or more. In another preferred embodiment, the film has a total light transmittance of about 95% or more.

In another preferred embodiment, the layer advantageously has an optical transparency retention of about 80% to about 99.9% of that of any base material before nanotubes are added.

In another preferred embodiment, the layer has a haze value less than 1%. In another preferred embodiment, film has a haze value less than 0.5%.

Solar absorptivity pertains to the fraction of incoming solar energy that is absorbed by the film. Advantageously, the layers of the instant invention have low solar absorptivity. Preferably, the layer has a solar absorptivity of less about 0.3. Even more preferably, the layer has a solar absorptivity of between about 0.01 to about 0.2.

The instant layer may range in thickness between about 0.5 nm to about 1000 microns.

In another preferred embodiment, the layer further comprises a polymeric material. The polymeric material may be selected from a wide range of natural or synthetic polymeric resins. The particular polymer may be chosen in accordance with the strength, structure, or design needs of a desired application. In a preferred embodiment, the polymeric material comprises a material selected from the group consisting of thermoplastics, thermosetting polymers, elastomers and combinations thereof. In another preferred embodiment, the polymeric material comprises a material selected from the group consisting of polyethylene, polypropylene, polyvinyl chloride, styrenic, polyurethane, polyimide, polycarbonate, polyesters, fluoropolymers, polyethers, polyacrylates, polysulfides, polyamides, acrylonitriles, cellulose, gelatin, chitin, polypeptides, polysaccharides, polynucleotides and mixtures thereof. In another preferred embodiment, the polymeric material comprises a material selected from the group consisting of ceramic hybrid polymers, phosphine oxides and chalcogenides.

In a preferred embodiment, the layer may further have an additive selected from the group consisting of a dispersing agent, a binder, a cross-linking agent, a stabilizer agent, a coloring agent, a UV absorbent agent, and a charge adjusting agent. Particularly, the nanotubes may be combined with additives to enhance electrical conduction, such as conductive polymers, particulate metals, particulate ceramics, salts, ionic additives and mixtures thereof.

The layer may be easily formed and applied to a substrate as a dispersion of nanotubes alone in such solvents as acetone, water, ethers, and alcohols. The solvent may be removed by normal processes such as air drying, heating or reduced pressure to form the desired film of nanotubes. The layer may be applied by other known processes such as spray painting, dip coating, spin coating, knife coating, kiss coating, gravure coating, screen printing, ink jet printing, pad printing, other types of printing or roll coating.

The instant films may be in a number of different forms including, but not limited to, a solid film, a partial film, a foam, a gel, a semi-solid, a powder, or a fluid.

In a preferred embodiment, the instant nanotube films can themselves be over-coated with a polymeric material. In this way, the invention contemplates, in a preferred embodiment, noyel laminates or multi-layered structures comprising films of nanotubes overcoated with another coating of an inorganic or organic polymeric material. These laminates can be easily formed based on the foregoing procedures and are highly effective for distributing or transporting electrical charge. The layers, for example, may be conductive, such as tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, or a doped oxide layer, or a hard coat such as a silicon coat. In this way, each layer may provide a separate characteristic.

In a preferred embodiment, the nanotubes are oriented by exposing the films to a shearing, stretching, or elongating step or the like, e.g., using conventional polymer processing methodology. Such shearing-type processing refers to the use of force to induce flow or shear into the film, forcing a spacing, alignment, reorientation, disentangling etc. of the nanotubes from each other greater than that achieved for nanotubes simply formulated either by themselves or in admixture with polymeric materials. Oriented nanotubes are discussed, for example in U.S. Pat. No. 6,265,466, which is incorporated herein by reference in its entirety. Such disentanglement etc. can be achieved by extrusion techniques, application of pressure more or less parallel to a surface of the composite, or application and differential force to different surfaces thereof, e.g., by shearing treatment by pulling of an extruded plaque at a variable but controlled rate to control the amount of shear and elongation applied to the extruded plaque. It is believed that this orientation results in superior properties of the film, e.g., enhanced electromagnetic (EM) shielding.

The layers of the instant invention advantageously achieve acceptable electrical conductivity while not negatively effecting properties of polymeric materials in the layer. In fact, properties of base polymeric materials can be substantially maintained after addition of nanotubes effective for electrostatic discharge. For example, in a preferred embodiment, the layer has a tensile elongation retention of at least 50% of that of a nanotube-free base polymeric materials. More preferably, the layer has a tensile elongation retention of at least 70% of that of a nanotube-free base polymeric materials. Even more preferably, the layer has a tensile elongation retention of at least 90% of that of a nanotube-free base polymeric materials. In another preferred embodiment, the layer has a coefficient of thermal expansion (CTE) that is at least 50% of that of a nanotube-free base polymeric material. More preferably, the layer has a coefficient of thermal expansion (CTE) that is at least 70% of that of a nanotube-free base polymeric material. Even more preferably, the layer has a coefficient of thermal expansion (CTE) that is at least 90% of that of a nanotube-free base polymeric material.

In a particularly preferred embodiment, the invention provides A spacecraft comprising a surface defining said spacecraft, wherein said surface comprises a layer of nanotubes effective for electrostatic discharge; wherein said nanotubes are selected from the group consisting of single-walled nantubes (SWNTs), double-walled nantubes (DWNTs), multi-walled nanotubes (MWNTs), and mixtures thereof; wherein the layer has a surface resistance in the range of about 10⁵ to about 10¹² ohms/square; wherein the layer has a thickness between about 0.5 nm to about 1000 microns; and wherein the layer has optical transparency retention of about 80% to about 99.9% that of a nanotube-free base material.

Oriented refers to the axial direction of the nanotubes. The tubes can either be randomly oriented, orthoganoly oriented (nanotube arrays), or preferably, the nanotubes are oriented in the plane of the film.

The present invention, thus generally described, will be understood more readily by reference to the following examples, which are provided by way of illustration and are not intended to be limiting of the present invention.

### EXAMPLES

Solar Absorptivity and Thermal Emissivity

Experimental

Solar absorptivities (a) of thin films were measured on an AZTek Model LPSR-300 spectroreflectometer with measurements taken between 250 to 2800 nm with a vapor deposited aluminum on Kapton® film (1st surface mirror) as a reflective reference per ASTM E903-82. An AZTek Temp 2000A infrared reflectometer was used to measure the thermal emissivity (ε) of thin films.

Discussion

Two of several important properties of materials for space applications are solar absorptivity (α) and thermal emissivity (ε). Solar absorptivity pertains to the fraction of incoming solar energy that is absorbed by the film and ε is a measure of the films ability to radiate energy from the film surface. These two properties will, to a large degree, determine the equilibrium temperature of the material in a particular environment. Typically a low colored film exhibits a low α value.

Transparency

UV/VIS spectra were obtained on thin films using a Perkin-Elmer Lambda 900 UV/VIS/NIR spectrometer over the wavelength range of 250-900 nm. Thin films were measured for optical transparency using UV/visible spectroscopy with the percent transmission at 550 nm (the solar maximum) reported.

Comparison of Electrical Properties for MWNT (Hyperion and Carbolex) and SWNT (CNI (Laser Ablated and HiPCO))

The nanotubes in Table 1 were sonicated for eight minutes into Titanium SI-DETA (ceramer hybrid resin, this work has been repeated for other resin systems like epoxy and urethane) and then cast onto a glass or polycarbonate slide. A set of Hyperion MWNT was sonicated in toluene then rinsed in IPA and added to the Titanium SI-DETA were it was sonicated for another 4 minutes. The thickness of the cast films is 0.5 mils thick.

TABLE 1
Surface Resistance Units at Ohms/sq and % T at 550 nm

| | | | Hyperion | | | | | |
|---|---|---|---|---|---|---|---|---|
| Wt. % | | | MWnT | % T | Bucky | | | |
| Nanotubes | Hyperion | | Toluene | Toluene | USA | | CNI | |
| Dry Wt. | MWnT | % T | Extracted | Extracted | MWnT* | % T | | |
| 0.04 | | | | | | | 2.2E+9 | 84.5 |
| 0.06 | | | | | | | 3.5E+7 | 73.5 |
| 0.08 | | | | | | | 3.5E+7 | 76.2 |
| 0.10 | >1.0E+11 | 92 | >1.0E+11 | 85.5 | >1.0E+11 | 94.4 | 4.5E+7 | 80.2 |
| 0.20 | >1.0E+11 | 88.1 | >1.0E+11 | 77.4 | >1.0E+11 | 94.2 | 1.0E+7 | 70.0 |
| 0.30 | >1.0E+11 | 88.7 | >1.0E+11 | 74.1 | >1.0E+11 | 93.1 | 7.5E+6 | 59.4 |
| 0.40 | >1.0E+11 | 85.7 | | | >1.0E+11 | 92.5 | 1.7E+6 | 54.8 |
| 0.50 | >1.0E+11 | 82.2 | >1.0E+11 | 63.4 | >1.0E+11 | 92 | | |
| 1.00 | >1.0E+11 | 68.5 | 3.5E+9 | 37.5 | >1.0E+11 | 84.7 | | |
| 2.00 | >1.0E+11 | 46.9 | 6.0E+6 | 15.2 | >1.0E+11 | 81.5 | | |
| 3.00 | >1.0E+11 | 41.6 | 3.25E+6 | 5.4 | >1.0E+11 | 79.8 | | |

U.S. Pat. No. 5,908,585 discloses a film having two conductive additives. In this table they did not create a film with high enough conductivity to qualify as an ESD films (<10E10 Ohms/sq). Only when they add a substantial (>20%) loading of conductive metal oxide does the films function as claimed. All claims are founded on this use of both fillers.

Optical Properties, Transmission, Color and Haze for Three Coatings. 0.1%, 0.2%, and 0.3% SWNT in Ceramer Coating

TABLE 2
Haze Test Results for Si-DETA-50-Ti
coatings on glass at 18 um thickness

| Sample | | Thickness | | Total Luminous | Diffuse |
|---|---|---|---|---|---|
| Name | Number | inches | Haze % | Transmittance (%) | Trans % |
| Blank | 1 | 0.044 | 0.1 | 92.0 | 0.1 |
| | 2 | 0.044 | 0.1 | 92.0 | 0.1 |
| | 3 | 0.044 | 0.1 | 92.0 | 0.1 |
| | Average | | 0.1 | 92.0 | 0.1 |
| 0.1% | 1 | 0.044 | 3.2 | 85.2 | 3.8 |
| SWNT | 2 | 0.044 | 3 | 85.0 | 3.5 |
| | 3 | 0.044 | 3 | 85.2 | 3.5 |
| 0.2% | 1 | 0.044 | 3.8 | 81.9 | 4.6 |
| SWNT | 2 | 0.044 | 4.3 | 81.3 | 5.3 |
| | 3 | 0.044 | 3.7 | 81.9 | 4.5 |
| | Average | | 3.9 | 81.7 | 4.8 |
| 0.3% | 1 | 0.044 | 5.7 | 76.8 | 7.4 |
| SWNT | 2 | 0.044 | 5.5 | 77.3 | 7.1 |
| | 3 | 0.044 | 5.6 | 76.9 | 7.3 |
| | Average | | 5.6 | 77.0 | 7.3 |

| | Color | | | | | |
|---|---|---|---|---|---|---|
| | Scale XYZ | | 1 | 2 | 3 | AVE |
| BLANK | C2 | X | 90.18 | 90.19 | 90.18 | 90.18 |
| | | Y | 91.99 | 92.00 | 91.99 | 91.99 |
| | | Z | 108.52 | 108.53 | 108.52 | 108.52 |
| | F2 2 | X | 16.18 | 16.18 | 16.18 | 16.18 |
| | | Y | 26.98 | 26.99 | 26.99 | 26.99 |
| | | Z | 124.83 | 124.84 | 124.83 | 124.83 |
| | A 2 | X | 101.05 | 101.06 | 101.05 | 101.05 |
| | | Y | 91.99 | 92.00 | 92.00 | 92.00 |
| | | Z | 32.67 | 32.67 | 32.67 | 32.67 |
| 0.1% SWNT | C2 | X | 83.31 | 83.13 | 83.23 | 83.22 |
| | | Y | 85.23 | 85.04 | 85.15 | 85.14 |
| | | Z | 97.89 | 97.75 | 97.76 | 97.80 |
| | F2 2 | X | 15.01 | 14.97 | 14.99 | 14.99 |
| | | Y | 25.18 | 25.12 | 25.16 | 25.15 |
| | | Z | 115.77 | 115.50 | 115.65 | 115.64 |
| | A 2 | X | 93.87 | 93.65 | 93.78 | 93.77 |
| | | Y | 85.38 | 85.18 | 85.30 | 85.29 |
| | | Z | 29.57 | 29.52 | 29.53 | 29.54 |
| 02% SWNT | C2 | X | 80.21 | 79.55 | 80.17 | 79.98 |
| | | Y | 81.93 | 81.25 | 81.89 | 81.69 |
| | | Z | 95.01 | 94.15 | 94.96 | 94.71 |
| | F2 2 | X | 14.43 | 14.30 | 14.42 | 14.38 |
| | | Y | 24.19 | 23.99 | 24.18 | 24.12 |
| | | Z | 111.26 | 110.32 | 111.20 | 110.93 |
| | A 2 | X | 90.20 | 89.46 | 90.15 | 89.94 |
| | | Y | 82.04 | 81.37 | 82.00 | 81.80 |
| | | Z | 38.65 | 28.40 | 28.64 | 31.90 |
| 0.3% SWNT | C2 | X | 75.13 | 75.65 | 75.24 | 75.34 |
| | | Y | 76.78 | 77.32 | 76.90 | 77.00 |
| | | Z | 88.29 | 88.96 | 88.42 | 88.56 |
| | F2 2 | X | 13.53 | 13.62 | 13.55 | 13.57 |
| | | Y | 22.74 | 22.88 | 22.77 | 22.80 |
| | | Z | 104.30 | 105.02 | 104.46 | 104.59 |
| | A 2 | X | 84.63 | 85.20 | 84.74 | 84.86 |
| | | Y | 76.94 | 77.47 | 77.06 | 77.16 |
| | | Z | 26.65 | 26.85 | 26.69 | 26.73 |

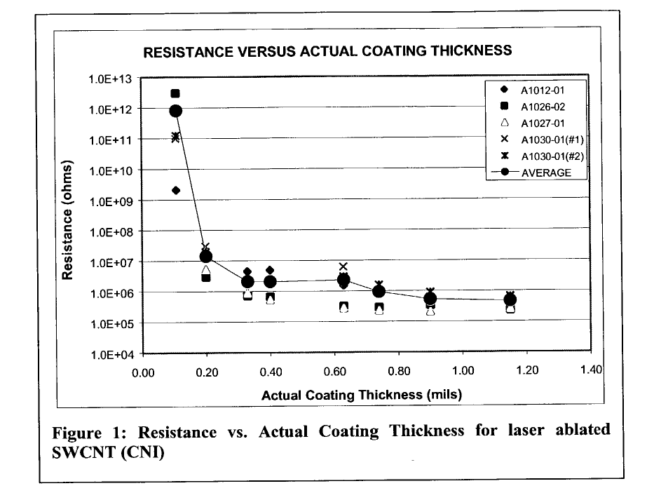

Referring to FIG. 1, a plot of conductivity verses thickness for SWNT coatings is provided. Note that new HiPCO CNI nanotubes provide lower resistance.

Conductivity Verses Humidity for SWNT coatings

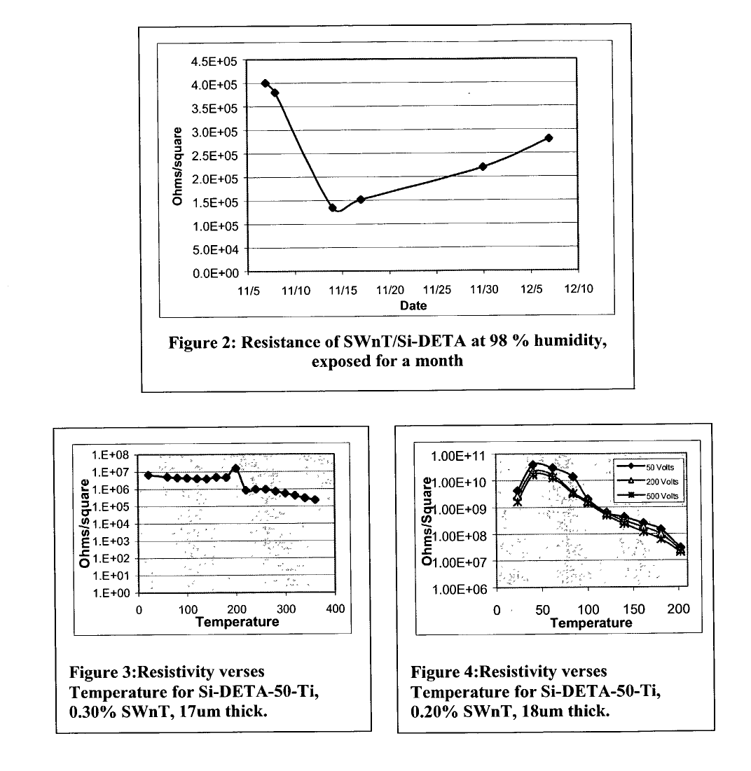

Referring to Table 3 and FIG. 2, humidity does not affect the electrical conductivity of the SWNT/Si-DETA coating. FIG. 2 shows the affect of high humidity over an extended period of time. The resistance was unchanged over a month at saturated conditions.

TABLE 3
Temperature in ° C.

| Date | Temperature | Percent Humidity | Ohms/Square |
|---|---|---|---|
| Nov. 4, 2000 | 23 | 40 | 1.2E+5 |
| Nov. 6, 2000 | 23 | 6 | 1.38E+5 |
| Nov. 7, 2000 | 23 | 98 | 4.0E+5 |
| Nov. 8, 2000 | 23 | 98 | 3.8E+5 |
| Nov. 14, 2000 | 23 | 98 | 1.35E+5 |
| Nov. 17, 2000 | 23 | 98 | 1.52E+5 |
| Nov. 30, 2000 | 22 | 98 | 2.2E+5 |
| Dec. 7, 2000 | 21 | 98 | 2.8E+5 |

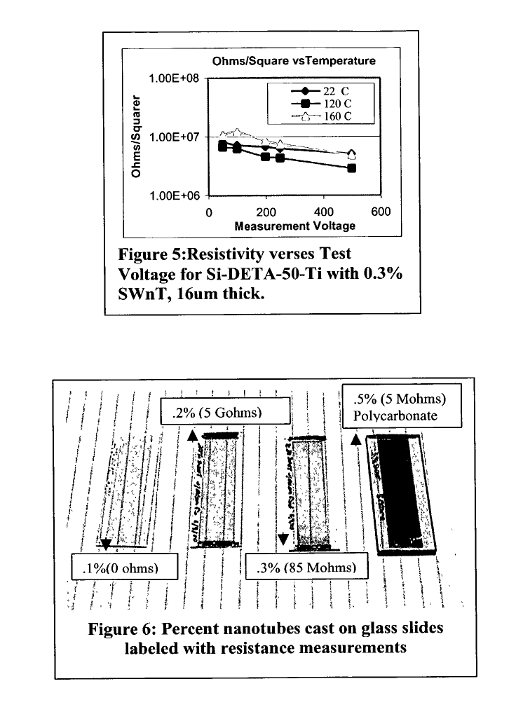

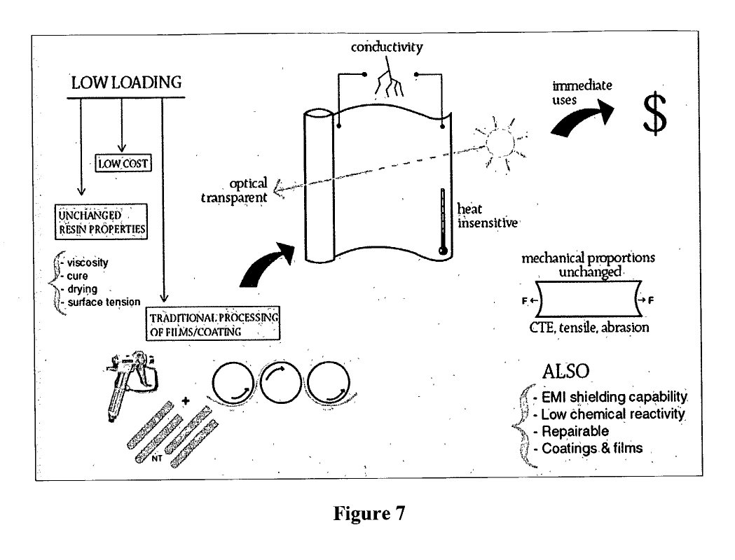

Referring to FIG. 3, surface resistivity data for Si-DETA-50-Ti with 0.3% SWNT cast on to a glass slide is shown. The test period was over eight days with long soak times at each temperature. Very little hysteresis was observed, from starting values, when the sample was removed from the apparatus and returned to room temperature several times during the test. Note that the sample turned dark brown and cracked once the temperature exceeded 300° C. It is also interesting to note that even though the sample looked destroyed after testing it still had nearly the same resistivity as prior to testing. This test was repeated using a sample with lower loading of SWNT (0.2%) cast from the same batch of ceramer resin, see FIG. 4. The dependence on test voltage is also depicted. The ASTM test voltage is 500V, preferred. Actual static charge is much higher, up to 20,000V. Apparently, the ceramer ESD coating has reduced resistivity with increasing voltage. The peak at 50 to 100° C. may be due to moisture. The present inventors have noted reduced magnitude during second cycle of testing the same specimen. The voltage dependence is shown in detail in FIG. 5.

Based on, the foregoing, it is projected that the surface resistivity of the nanotubes will remain constant after exposure to temperatures exceeding 800° C., and at temperatures exceeding 1000° C. Thus, the coating provides substantially the same ESD protection even after high temperature exposure.

FIG. 6 shows the percent nanotubes cast on glass slides labeled with resistance measurements.

ESD Coatings

Electrical conductivity to a resin system without adversely affecting the other physical properties is demonstrated. This data presented in this section was obtained using three polyimides; POLYIMIDE-l (CP-1 from SRS), POLYIMIDE-2 (CP-2 from SRS), and TPO (triphenyl phosphine oxide polymer (TOR-NC) from Triton Systems, Inc.). Similar results to those presented herein, have been collected on other resins and are expected from most other polymer resins useful for film forming and coatings applications.

Summary of Results

Electrical conductivity has been imparted to a resin system without adversely affecting other physical properties. Data presented in this section demonstrate three polyimides; POLYIMIDE-1, POLYIMIDE-2, and TPO. Similar results to those presented herein, have been collected on other resins and are expected from most other polymer resins useful for film forming and coatings applications.

Successful incorporation of SWNTs into ESD films and coatings are listed here with summary of results obtained:

A) Electrical resistivity; concentration, and thickness of nanotube filled films. Resistivity easily adjusted from 10² to 10¹² Ohm/sq at any thickness greater than 1 micron. Resistivity through bulk or surface of films demonstrated with very high optical clarity and low haze.

B) Thermal effect on conductivity. Resistivity insensitive to temperature and humidity from at least −78 to +300° C. Resistivity lowers with increasing voltage. Resistivity insensitive to temperature cycling and soak.

C) Optical transparency of SWNT filled matrix for window and lens applications. Transmission loss of only 10-15% for 25 micron thick films with bulk conductivity. Transmission loss of only 1-5% for thinner 2-10 micron conductive films. Haze values typically <1%. Mechanical property changes to the resin and final films due to presence of nanotubes. Tensile, modulus, and elongation to break unaffected by addition of nanotubes. Coefficient of thermal expansion unaffected by addition of nanotubes. No other qualitative differences between films with or without nanotubes observed.

D) Processing of resin and films unaffected by incorporation of nanotubes. Viscosity, surface tension, wetting, equivalent to unfilled resin. Casting, drying, curing, film parting, and final surface appearance identical. In special cases of high nanotube loading some viscosity increase is observed.

E) Formulation of the SWNT homogeneously throughout the matrix for uniform properties. Large area (2 ft. sq.) films have very uniform electrical characteristics. Processing is scalable using continuous homogenizers and mixers. Some inclusions due in part to impurities in nanotubes still present a challenge.

Each of these key areas is presented in detail following a brief discussion on experimental plan.

The films and coatings used for testing form two classes. The first class of films are those made for comparative properties testing between POLYIMIDE-1, POLYIMIDE-2, and TPO films with and without nanotubes. In this matrix of films samples, all preparation conditions, procedures, and materials were identical for the films made with or without nanotubes. A uniform final film thickness of 25 microns was also maintained. The loading concentration of SWNTs was determined from preliminary test films created with nanotube filling weight percentage between 0.03 to 0.30%. From this test, the films were standardized to 0.1% to give films with resistivity between 10⁵-10⁹ Ohms/sq. During the concentration test films with resistivity from 50 Ohms/sq to over 10¹² Ohms/Sq were able to be made. Lastly, the film thickness was selected to be 1 mil (25 um) since current application make use of this thickness and based on observations that resistivity, at a set concentration of nanotubes, does not vary with thickness unless film is below 2 microns. This resulting set of specimens was used in a test matrix comparing: 1) electrical resistivity at various temperatures, 2) optical transmittance and haze, 3) mechanical properties of tensile, modulus, elongation, and 4) coefficient of thermal expansion (CTE). The preparation and results of testing the films in this matrix are presented as listed above.

The second class of films and coatings for testing were prepared by various means and represent special coatings and films which demonstrate the wide variety of properties attainable using this nanotechnology enhancement to these resins. For example, these samples include measurement of resistivity as a function of the film thickness and nanotube loading level. The methods used for preparation of these special demonstrations are presented.

Preparation and Test Results for Films in Comparative Matrix

The materials used were POLYIMIDE-1 and POLYIMIDE-2, and TPO. Both POLYIMIDE-1 and POLYIMIDE-2 were cast at a final concentration of 15% while TPO was cast at a final concentration of 20% in n-methyl pyrrolidone (NMP). To prepare the resins for casting, each resin was placed in a three-neck round bottom flask with enough NMP to make more concentrated 20% solution for POLYIMIDE-1 and POLYIMIDE-2 and a 25% solution for TPO. This concentrate is later reduced by the addition of NMP and nanotubes. The resins were made in large batches, purged with nitrogen and stirred at 30 RPM for 18 hours. Each batch of resin was split in half and placed into two fresh flasks. Then two aliquots of NMP were placed in small jars for cutting the concentration of resin to casting viscosity. SWNTs were weighed out and added to pure NMP. The SWNTs and NMP were sonicated for 12 minutes. To one flask of resin concentrate, an aliquot of pure NMP was added to the concentrate while the other half of the resin solution an aliquot of NMP containing SWNTs was added. Both flasks were stirred at 30 RPM for half an hour, filtered and placed in jars for casting. Through the task of preparing the resins for casting, attention to stirring, mixing and other details were standardized to keep processing of the virgin and 0.1% SWNT resins the same.

The samples were cast onto ¼ inch thick glass panels that were cleaned with soap and water and then rinsed in pure water and allowed to dry. The glass was washed and with methanol and a lint free cloth. The samples were cast two inches wide using a casting knife to make a final thickness of 1 mil. For POLYIMIDE-1 and POLYIMIDE-2 a 12.5 mil casting thickness was used while TPO required 10-mil casting to achieve 1 mil. The cast samples were died at 130° C. overnight and then at 130° C. under vacuum for an hour. The thin samples prepared for optical testing were not removed from the glass but dried and heated like all the other coatings. The films were then floated off the glass by using purified water, to reduce water spots. After drying, the samples were tested for residual solvents using a thermal galvimetric analysis (TGA). The remaining solvent was about 10, which was too high. The samples were then taped on the glass panels using Kapton tape and heated to 130° C. under vacuum for 18 hours. Using the TGA again to check for solvent content it was found that the coatings were reduced to about 3-6% solvent. The samples were placed back into the oven and heated to 160° C. under vacuum for 18 hours. After this heating process the solvent levels were below 2% and used for testing.

The following test results were obtained: 1) electrical resistivity at various temperatures; 2) optical transmittance and haze; 3) mechanical properties of tensile, modulus, elongation; and 4) coefficient of thermal expansion (CTE).

Resistivity in Comparative Matrix as a Function of Temperature, Voltage, and Humidity.

Background:

To impart the conductive path throughout a structure, a three-dimensional network of filler particles was required. This is referred to as percolation threshold and is characterized by a large change in the electrical resistance. Essentially, the theory is based on the agglomeration of particles, and particle-to-particle interactions resulting in a transition from isolated domains to those forming a continuous pathway through the material. Nanotubes have a much lower percolation threshold than typical fillers due to their high aspect ratio of >1000 and high conductivity. As and example, the calculated percolation threshold for carbon black is 3-4% while for typical carbon nanotubes the threshold is below 0.04% or two orders of magnitude lower. This threshold value is one of the lowest ever calculated and confirmed. (See J. Sandler, M. S. P. Shaffer, T. Prasse, W. Bauhofer, A. H. Windle and K. Schulte, “Development of a dispersion process for catalytically grown carbon nanotubes in a epoxy matrix and the resulting electrical properties”, University of Cambridge, United Kindom, and the Technical University Hamburg-Hamburg, Germany).

The high conductivity imparted when SWNT's are dispersed in a polymer at low concentrations (0.05 to 2-wt. %) is not typically observed in a filled material. This is one of the most attractive aspects to using SWNT's to make conductive materials. For a typical filled system, like polyaniline (PAN) particles in a polymer matrix, a 6 to 8% volume fraction is required to reach percolation threshold for conductivity. Even when PAN is solution blended the loading exceeds 2 wt. %. Another, more common example is found in ESD plastics used in the electronics industry were polymers are filled with carbon black to a loading of 10 to 30-wt. %.

The high conductivity at low concentration is due to the extraordinarily high aspect ratio of SWNTs and the high tube conductivity. In fact, the electrical conductivity of individual tubes has been measured and determined to exhibit metallic behavior.

Electrical Resistivity and Thermal Stability.

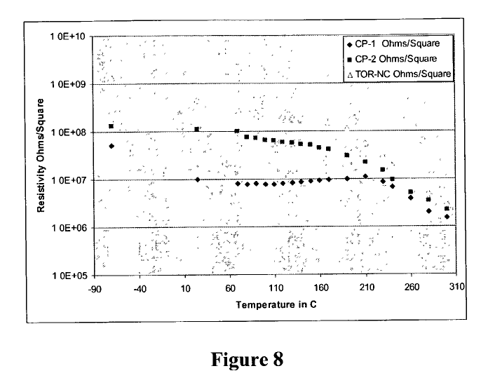

To demonstrate the thermal stability through a wide range of temperatures we mounted samples from each film in the test matrix onto glass slides using Kapton tape. These slides were placed in an environmental test chamber with leads attached to silver-metal painted stripes on each of the three types, POLYIMIDE-1, POLYIMIDE-2, and TPO. The results showing how each of the three films resistivity varied with temperature from −78 to +300° C., are presented in FIG. 8.

The results indicate that electrical resistivity in all three films is insensitive to a wide range of temperatures. The relative value of resistivity between the films is not important since it can be adjusted easily by changing the concentration of the tubes. However, in general TPO has a high resistivity at a given nanotube concentration in all the samples made in the phase I. This data also indicates that imparting conductivity to polymer by addition of SWNTs will produce a film with excellent thermal stability, at least as good as the base resins. These films were cycled through this test several times without any notable change in resistivity. In addition, the films were left then to soak for a period of 63 hours in air at 250° C. to observe the long-term stability as shown in Table 4.

TABLE 4
Resistivity (Ohms/sq.) vs. Time

| | POLYIMIDE- | POLYIMIDE- | |
|---|---|---|---|
| Hours at 250 C. | 1 | 2 | TPO |
| 0 | 3.0E+6 | 5.4E+6 | 6.3E+6 |
| 63 | 4.4E+6 | 6.1E+6 | 7.8E+6 |

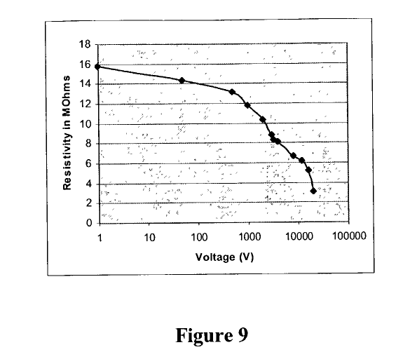

Also of interest was the relationship between test voltage and measured resistivity. The resistivity was calculated by holding the test voltage constant and recording the current across the sample using ohms law. POLYIMIDE-1 coated on glass with 0.1% SWNTs was tested from 1 Volt to 20 KV, with the calculated resistivity, normalized to Ohms/sq, plotted in FIG. 9. This graph shows that the resistance of these films reduces with increasing voltage. This is also observed at elevated temperatures. From a design stand point, this meant those films tested using low voltage meters were adequate, since resistances would only decrease if the films were subjected to higher voltages during the application. In fact these carbon nanocomposite films may be developed for lightening protection.

To test thermal stability, samples of each of the six films in the test matrix were scanned by TGA and DSC to evaluate how they behave with and without nanotube present. The percent weight loss at 350° C. and the glass transition temperature was recorded. See Tables 5 and 7 for results:

TABLE 5
TGA Data on POLYIMIDE-1, POLYIMIDE-2 and
TPO films with and with nanotubes

| Sample | % Weight loss |
|---|---|
| Description | @ 350° C. |
| Virgin | 1.57 |
| POLYIMIDE-1 | |
| POLYIMIDE-1 | 1.46 |
| w/ SWnT | |
| Virgin | 3.50 |
| POLYIMIDE-2 | |
| POLYIMIDE-2 | 457 |
| w/ SWnT | |
| Virgin TPO | 3.64 |
| TPO w/ SWnT | 4.65 |

TABLE 6
DSC Data on POLYIMIDE-1, POLYIMIDE-2, TPO Films

| | Glass Transition | |
|---|---|---|
| Sample | Temperature T_{g} | Reported T_{g} |
| Description | (° C.) | (° C.) |
| POLYIMIDE-1 | 248.3 | 263 |
| Virgin | | |
| POLYIMIDE-1 w/ | 249.7 | |
| SWnT | | |
| POLYIMIDE-2 | 163.8 | 209 |
| Virgin | | |
| POLYIMIDE-2 w/ | 162.4 | |
| SWnT | | |
| TPO Virgin | 172.4 | N/A |
| TPO w/ SWnT | 186.8 | |

The decrease in the TGA and T_{g} of the films is a result of residual NMP trapped in the film. The TPO resin did not give a clean or good DSC curve until thermally cycled a couple times.

Summary of Electrical Test Results.

Films have electrical resistivity much lower than required for ESD applications and can be easily designed for any level of electrical resistance above a 100 Ohms/sq. using very low loading level of nanotubes. Electrical properties are insensitive to temperature, humidity, ageing. The presence of the nanotube does not harm the other thermal properties of the films.

Optical Transmittance and Haze.

SWNTs are excellent additives to impart conductivity to polymeric systems and consequently function well in an ESD role. However, for application to optics and windows, the resulting films or coatings must also be transparent. Samples of each film made for the comparative test matrix were tested using ASTM D1003 “Standard Test Method for Haze and Luminous Transmittance of Transparent Plastics” This test method covers the evaluation of specific light-transmitting and wide-angle-light-scattering properties of planar sections of materials such as essentially transparent plastic. A procedure is provided for the measurement of luminous transmittance and haze. We also tested thinner films made from the same resin batch. This data is presented in Table 7. For comparison, the same films were tested for %T at fixed frequency of 500 nm using a Beckman UV-Vis spectrometry on both glass, see Table 8, and as free standing films, see Table 9.

TABLE 7
ASTM D1003-00B, optical haze, luminous and diffuse transmittance
data for films with and without nanotubes. Note all thee films
are conductive in the ESD range

| | | Ohms | | Total | Diffuse |
|---|---|---|---|---|---|
| | Thickness | per | Haze | Luminous | Trans |
| Sample Identification | Microns | Square | % | Trans % | % |
| Test Matrix Films, Free | | | | | |
| Standing | | | | | |
| POLYIMIDE-2 Virgin film | 27 | >1.0 × 10¹² | 1.4 | 88.9 | 1.6 |
| POLYIMIDE-2 With 0.1% | 27 | 1.6 × 10⁶ | 3.1 | 62.7 | 5.0 |
| SWnT film | | | | | |
| TPO Virgin film | 30 | >1.0 × 10¹² | 1.5 | 86.8 | 1.7 |
| TPO With SWnT film | 30 | 5.0 × 10⁸ | 1.0 | 70.7 | 1.4 |
| POLYIMIDE-1 Virgin film | 25 | >1.0 × 10¹² | 0.7 | 90.2 | 0.8 |
| POLYIMIDE-1 With SWnT | 25 | 1.4 × 10⁷ | 1.1 | 64.8 | 1.7 |
| film | | | | | |
| Thin Films/Coatings on Glass | | | | | |
| Blank | NA | NA | 0.3 | 88.5 | NA |
| POLYIMIDE-1 Virgin | 4 | >1.0 × 10¹² | 0.1 | 99.2 | 0.1 |
| POLYIMIDE-1 With 0.1% | 4 | 3.0 × 10⁸ | 0.3 | 93.6 | 0.3 |
| SWnT | | | | | |
| POLYIMIDE-1 Virgin | 12 | >1.0 × 10¹² | 0.3 | 99.0 | 0.3 |
| POLYIMIDE-1 With 0.1% | 12 | 1.9 × 10⁷ | 0.4 | 85.0 | 0.4 |
| SWnT | | | | | |

POLYIMIDE-1 was cast onto glass substrates with and without SWNTs at 2 and 6 mils thick. An additional ultrathin sample was prepared using POLYIMIDE-1 compounded with 0.3% SWNTs and cast at 0.5 mil thick. These samples were tested on the UV-Vis spectrometer for percent transmission at 500 nm, an industry standard for comparison. The glass was subtracted out of each sample. Table 8 presents the optical and resistivity data for these samples cast on glass. The same tests were run on POLYIMIDE-2 and TPO, with very similar results.

TABLE 8
POLYIMIDE-1 on glass

| | | Resistivity in |
|---|---|---|
| Sample Description | % T @ 500 nm | Ohms/Sq. |
| POLYIMIDE-1 with 0.1% SWnT | 77.3 | 3.0E+8 |
| at 4 um | | |
| POLYIMIDE-1 with 0.1% SWnT | 75.2 | 1.9E+7 |
| at 12 um | | |
| Virgin POLYIMIDE-1 at 4 um | 83.7 | >10¹³ |
| Virgin POLYIMIDE-1 at 12 um | 89.2 | >10¹³ |

Another set of samples were cast at the same thickness and removed from the glass. The freestanding films were also analyzed using the UV-Vis at 500 nm. Table 9 represents the results of the freestanding films.

TABLE 9
Freestanding POLYTMIDE-1

| | | Resistivity in |
|---|---|---|
| Sample Description | % T @ 500 nm | Ohms/Sq. |
| POLYIMIDE-1 with 0.1% | 77.3 | 30E+8 |
| SWnT at 4 um | | |
| POLYIMIDE-1 with 0.1% | 75.2 | 1.9E+7 |
| SWnT at 12 um | | |
| Virgin POLYIMIDE-1 at 4 um | 83.7 | >10¹³ |
| Virgin POLYIMIDE-1 at 12 um | 89.2 | >10¹³ |

Summary of Optical Test Results.

The optical testing of these ESD films in the test matrix demonstrates excellent transmission with low loss. Even more exciting are the results of thin film and bi-layer experiments where optical properties were the focus and result in near colorless (>75%T) films and coatings. With successful demonstration of optically clear, low resistivity films, the next step was to confirm that these films have the same or better mechanical properties as those not enhance with nanotubes.

Mechanical Properties of Tensile, Modulus, Elongation.

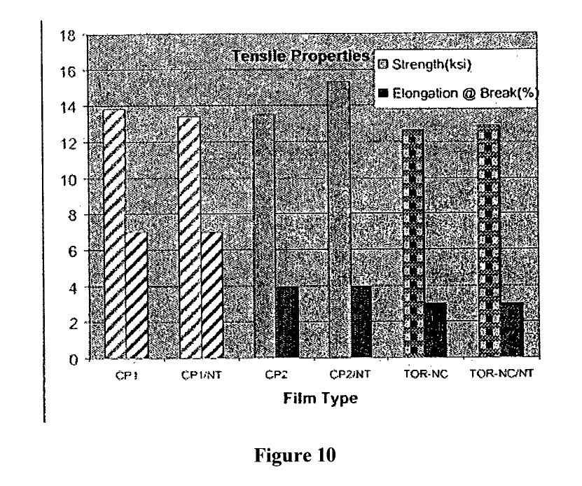

The use of these films in most application requires good mechanical properties. In this section, it is demonstrated that the presence of nanotube to impart the ESD characteristic does not adversely affect the mechanical properties of these polymer films. To that end, each type of film with and with out nanotube present was tested for tensile strength, tensile modulus, and elongation at break. The results of these tests are in Table 10 and graphed in FIG. 10.

Coefficient of Thermal Expansion (CTE).

SWNTs' ability to impart ESD characteristics does not adversely affect the coefficient of thermal expansion (CTE) properties of polymer films. To that end, each type of film with and with out nanotube present was tested. The CTE tests were conducted using Universal Testing Machine from SRS. The testing was conducted on 6 samples of film: Virgin POLYIMIDE-1, POLYIMIDE-1 with SWNT, Virgin POLYIMIDE-2, POLYIMIDE-2 with SWNT, Virgin TPO, and TPO with SWNT.

Each sample was first mounted onto a strip of 5 mil Kapton since the samples alone were slightly too short to be placed on the fixtures properly. Once the sample was fixed to the machine, the strain gage clamps were placed onto the film using a standard 4″ gage length. The film was then loaded with approximately 15 grams, which would provide a suitable stress to initiate elongation during heating but not permanent deformation.

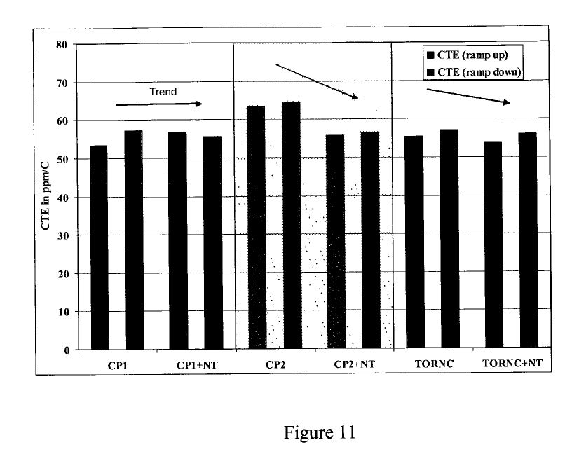

The POLYIMIDE-1 and POLYIMIDE-2 samples behaved as expected throughout the temperature range. The TPO samples behaved irregularly as compared to the polyimide. Initially, the samples appeared to shrink when heat was first applied then would grow normally as the temperature increased. The behavior seemed typical for the TPO VIR trial 1 on the ramp upward once the film normalized. Interestingly, the TPO material followed a different profile on the temperature ramp down and actually decreased in size before growing back to its original size. Another interesting behavior is that the TPO material seemed to change size if left to soak at 177C (350° F.) for any length of time. The virgin TPO shrank when soaked at 177° C. while the TPO with SWNTs grew when soaked at 177° C. Since the behavior was the same for both trials, it was determined that neither operator error nor instrument error was at fault. All CTE measurements fell within 10% of known values and are presented in Table 10 and in FIG. 11.

TABLE 10
The CTE values for each material

| Material | CTE (ramp up) | CTE (ramp down) |
|---|---|---|
| POLYIMIDE-1 | 53.27 ppm/C | 57.18 ppm/C |
| POLYIMIDE-1 with SWnT | 56.87 ppm/C | 55.58 ppm/C |
| POLYIMIDE-2 | 63.38 ppm/C | 64.45 ppm/C |
| POLYIMIDE-2 with SWnT | 56.00 ppm/C | 56.43 ppm/C |
| TPO (trial1) | 55.42 ppm/C | 57.04 ppm/C |
| TPO with SWnT (trial1) | 53.81 ppm/C | 56.13 ppm/C |
| TPO (trial2) | 50.70 ppm/C | 57.60 ppm/C |
| TPO with SWnT (trial2) | 60.86 ppm/C | 55.78 ppm/C |

Summary of CTE Testing

As with the tensile properties, the CTE properties of these films were generally unchanged by the addition of nanotubes. This will permit the use of these other polymers enhanced by the addition of nanotubes for coating and multilayer applications were CTE matching is important for bonding and temperature cycling.

Results Obtained from Exploratory Films and Coatings.

In this section are provided those results obtained from films and coating made from the same three resins, however, in these samples film thickness and nanotube concentration were not held fix. Samples were generated to demonstrate the ease at which very high clarity, high conductivity coatings and films can be produced using Nano ESD technology. In brief, the following samples were prepared and presented in the subsequent subsections of the proposal:

High clarity 1-2 micron thick coatings on glass with high loading levels of (0.2 and 0.3%) nanotubes.

Bilayer films, where very thin, high nanotube loading level is layered on standard thickness films.

Special polymer wrapped SWNT layered on 1 mil films.

High Clarity ESD Films

It is possible to obtain a highly absorbing film by increasing the nanotube concentration. A 1.5% loading level of multiwalled nanotubes in polymer matrix is black and dull in appearance. In contrast, an 8-micron thick polymer coating loaded with 0.2% SWNTs is still conductive yet nearly colorless. This coating was formed by casting a solution of POLYIMIDE-1 with 0.3% SWNTs@1.5 μm final thickness. It has a resistivity of 10⁸ Ohms sq with transparency 96%T with haze of 0.6%.

This excellent coating demonstrates that by manipulating the concentration and coating thickness excellent optical and electrical properties can be obtained in the same film. For comparison, the same sample was tested in our UV-Vis spectrometer at 500 nm. The glass complicates the results since the ESD layer acts as an antireflective coating to the glass and alters the reflective components contribution to the transmission result. Nevertheless, this coating demonstrates the potential for very high clarity ESD coatings.

TABLE 11
Transmission at 500 nm for thin 0.3% POLYIMIDE-1
coating on glass

| Sample | % T @ 500 nm w/ | Resistivity in |
|---|---|---|
| Description | glass subtracted | Ohms/Sq. |
| Ultrathin monolayer of | 83.8 | 3E+8 |
| POLYIMIDE-1 with 0.3% SWnT | | |
| 0.5 mil cast | | |
| Blank piece of glass | 88.8 | >10¹³ |

To reduce optical absorbance in nanocomposite conductive films the coating can be formed from a thin monolayer of high concentration nanotubes. Several other techniques have also been demonstrated to achieve the same high optical transparency while maintaining high electrical conductivity in the film. Two of the most successful rely on the same concept just shown, they are: 1) the use of bi-layers and 2) ultra thin polymer wrapped nanotubes.

Bi-Layer and Special Ultra Thin ESD Films.

A natural extension of the thin coating method for high optical clarity coatings, is to form a bi-layer free standing film by cast the thin 1 μm layer first on glass and then over coating with the thicker, 25 um layer of virgin resin. The resulting film has a conductive surface without conductivity through the thickness. We made films from the TPO resin to demonstrate the concept. The specifications for this film are provided in Table 12.

Nanotube concentration was increased to almost 50% in the conductive layer. This was done by modifying the nanotubes with a coating of polyvinylpyrrolidone (PVP). This is also referred to as wrapping the nanotubes with a helical layer of polymer. To accomplish this, SWNTs were suspended in sodium dodecy sulfate and PVP. This solution was then incubated at 50° C. for 12 hours and then flocculated with isopropyl alcohol. The solution is centrifuged and washed in water three times and then suspended in water. The resulting nanotubes are water soluble and easily sprayed or cast onto any surface. This solution was spray coated onto virgin films to create a fine coating (<1 um thick) that has ESD properties and is very clear and colorless.

The resulting coating can be coated with a thin binder while still remaining conductive or coated with a thicker layer to make free standing films. Using this technique, coatings with a resistivity down to 100 Ohms/sq were generated.

Although only a few exemplary embodiments of the present invention have been described in detail in this disclosure, those skilled in the art who review this disclosure will readily appreciate that many modifications are possible in the exemplary embodiments (such as variations in sizes, structures, shapes and proportions of the various elements, values of parameters, or use of materials) without materially departing from the novel teachings and advantages of the invention. Accordingly, all such modifications are intended to be included within the scope of the invention as defined in the appended claims.

Other substitutions, modifications, changes and omissions may be made in the design, operating conditions and arrangement of the preferred embodiments without departing from the spirit of the invention as expressed in the appended claims.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All references cited herein, including all U.S. and foreign patents and patent applications, are specifically and entirely hereby incorporated herein by reference, including the priority documents. It is intended that the specification and examples be considered exemplary only, with the true scope and spirit of the invention indicated by the following claims.

As used herein and in the following claims, articles such as “the”, “a” and “an” can connote the singular or plural.

1. A spacecraft comprising a surface defining at least a portion of said spacecraft, wherein said surface comprises a layer of carbon nanotubes effective for electrostatic discharge.

2. The spacecraft of claim 1, wherein said nanotubes are selected from the group consisting of single-walled carbon nantubes (SWNTs), double-walled carbon nantubes (DWNTs), multi-walled carbon nanotubes (MWNTs), modified carbon nanotubes, and mixtures and combinations thereof.

3. The spacecraft of claim 1, wherein the carbon nanotubes are substantially single-walled nantubes (SWNTs).

4. The spacecraft of claim 1, wherein the carbon nanotubes are present in said layer at about 0.001 to about 1% based on weight.

5. The spacecraft of claim 1, wherein the carbon nanotubes are substantially oriented.

6. The spacecraft of claim 1, wherein the layer has a surface resistance in the range of about 10⁵ to about 10¹² ohms/square.

7. The spacecraft of claim 1, wherein the layer has a surface resistance in the range of about 10⁷ to about 10¹⁰ ohms/square.

8. The spacecraft of claim 1, wherein the layer further comprises a polymeric material.

9. The spacecraft of claim 1, wherein the layer further comprises a polymeric material, wherein the polymeric material comprises a material selected from the group consisting of thermoplastics, thermosetting polymers, elastomers, conducting polymers and combinations thereof.

10. The spacecraft of claim 1, wherein the layer further comprises a polymeric material, wherein the polymeric material comprises a material selected from the group consisting of polyethylene, polypropylene, polyvinyl chloride, styrenic, polyurethane, polyimide, polycarbonate, polyesters, fluoropolymers, polyethers, polyacrylates, polysulfides, polyamides, acrylonitriles, cellulose, gelatin, chitin, polypeptides, polysaccharides, polynucleotides and mixtures thereof.

11. The spacecraft of claim 1, wherein the layer further comprises a polymeric material, wherein the polymeric material comprises a material selected from the group consisting of CP-1, TOR-LM, CP-2, TOR-NC, and mixtures thereof.

12. The spacecraft of claim 1, wherein the layer further comprises a polymeric material wherein the carbon nanotubes are dispersed substantially homogenously throughout the polymeric material.

13. The spacecraft of claim 1, wherein the layer further comprises an additive selected from the group consisting of a dispersing agent, a binder, a cross-linking agent, a stabilizer agent, a coloring agent, a UV absorbent agent, a charge adjusting agent, and combinations thereof.

14. The spacecraft of claim 1, wherein the layer has a thickness of from about 0.5 nm to about 1,000 microns.

15. The spacecraft of claim 1, wherein the layer is formed by a method selected from the group consisting of spray painting, dip coating, spin coating, knife coating, kiss coating, gravure coating, screen printing, ink jet printing, pad printing, and combinations thereof.

16. The spacecraft of claim 1, wherein the spacecraft is a gossamer spacecraft.

17. The spacecraft of claim 1, wherein the spacecraft comprises components selected from the group consisting of solar sails, antennas, sunshields, rovers, radars, solar concentrators, reflect arrays, and combinations thereof.

18. The spacecraft of claim 1, wherein the layer has a solar absorptivity of less than about 0.3.

19. The spacecraft of claim 1, wherein the layer has a solar absorptivity of between about 0.01 to about 0.2.

20. The spacecraft of claim 1, wherein the layer has optical transparency retention of from about 80% to about 99.9% that of a carbon nanotube-free base material.

21. The spacecraft of claim 2, wherein the carbon nanotubes are combined with additives to enhance electrical conduction, wherein said additive is selected from the group consisting of conductive polymers, particulate metals, particulate ceramics, salts, ionic additives, and mixtures thereof.

22. The spacecraft of claim 2, wherein the layer has a tensile elongation retention of at least 50% of that of a carbon nanotube-free base polymeric materials.

23. The spacecraft of claim 2, wherein the layer has a coefficient of thermal expansion (CTE) that is at least 50% of that of a carbon nanotube-free base polymeric material.

24. A spacecraft comprising a surface defining at least a portion of said spacecraft, wherein said surface comprises a layer of carbon nanotubes effective for electrostatic discharge;
wherein said nanotubes are selected from the group consisting of single-walled carbon nantubes (SWNTs), double-walled carbon nantubes (DWNTs), multi-walled carbon nanotubes (MWNTs), modified carbon nanotubes, and combinations and mixtures thereof;
wherein the layer has a surface resistance in the range of about 10⁵ to about 10¹² ohms/square;
wherein the layer has a thickness between about 0.5 nm to about 1000 microns; and
wherein the layer has optical transparency retention of about 80% to about 99.9% that of a nanotube-free base material.

25. A method for providing an electrostatic discharge to at least a portion of a surface of a spacecraft comprising applying carbon nanotubes to said portion.

26. The method of claim 25 wherein the carbon nanotubes are selected from the group consisting of single-walled carbon nantubes (SWNTs), double-walled carbon nantubes (DWNTs), multi-walled carbon nanotubes (MWNTs), modified carbon nanotubes, and combinations and mixtures thereof.

27. The method of claim 25 wherein the carbon nanotubes are applied in a layer with a thickness from about 0.5 nm to about 1000 microns.

28. The method of claim 27 wherein the layer has an optical transparency retention of about 80% to about 99.9% that of a carbon nanotube-free base material.
